(19) United States
(12) Patent Application Publication
(10) Pub. No.: US 2010/0204914 A1
(43) Pub. Date: Aug. 12, 2010

(54) Active widgets for mobile navigation systems

(75) Inventors: Assaf Gad, Petach Tikva (IL); Adi Avram, Haifa (IL); Tali Zvi, Givatayim (IL); Oren Nissim, Tzofit (IL)

Correspondence Address: D. Kligler I.P. Services LTD, P.O. Box 25, Zippori, 17910, IL

(73) Assignee: TELMAP LTD, Herzliya (IL)

(21) Appl. No.: 12/702,325

(22) Filed: Feb. 9, 2010

Related U.S. Application Data
(60) Provisional application No. 61/151,530, filed on Feb. 11, 2009.

(51) Int. Cl. G01C 21/36

(52) U.S. Cl. 701/201

(57) ABSTRACT

A method for communication includes running a navigation application on a mobile navigation device, so as to present to a user navigation instructions from a navigation server on the display of the mobile navigation device. A widget chosen by the user is activated to run on the mobile navigation device in conjunction with the navigation application. Responsively to activating the widget, an interactive user interface element is overlaid on the navigation instructions on the display, indicating an availability of a location-based service at a location specified by the navigation instructions. Upon receiving an input from the user via the interactive user interface element invoking the service, the service is provided to the user at the specified location via the mobile navigation device.

### CROSS-REFERENCE TO RELATED APPLICATION

This application claims the benefit of U.S. Provisional Patent Application 61/151,530, filed Feb. 11, 2009, which is incorporated herein by reference.

### FIELD OF THE INVENTION

The present invention relates generally to mobile navigation systems, and specifically to application programs for such systems.

### BACKGROUND OF THE INVENTION

A “widget” is a self-contained software module that provides a certain single-purpose interactive service. The widget accesses and uses data available from the operating system or from another application in order to display information to the user. Common computer desktop widgets show the user the latest news, weather, the time, a calendar, a dictionary, a map program, a calculator, or photographs from an album, for example.

Widgets are used in mobile devices for various purposes. For example, U.S. Patent Application Publication 2009/0144661, whose disclosure is incorporated herein by reference, describes a graphical user interface implemented on a “SmartPhone” device, which includes wireless connectivity features. A plurality of different widgets may be displayed on the device. These widget include a listing of movies, music, weather information, stock market information, travel information, and navigation information.

As another example, U.S. Patent Application Publication 2009/0276318, whose disclosure is incorporated herein by reference, describes a navigation device running basic navigation framework software, supporting a complete navigation content provision framework. The framework can support a fixed set of plug-in software object types, which can provide data and additional functionality to the navigation device. Plug-in software objects can be downloaded to the navigation device from a server which is also part of the framework. The download can be via a wireless network, during operation of the navigation device, and in response to user selections on the navigation device.

The description above is presented as a general overview of related art in this field and should not be construed as an admission that any of the information it contains constitutes prior art against the present patent application.

### SUMMARY

Embodiments of the present invention that are described hereinbelow provide software widgets for enhancing the functionality of mobile navigation devices.

There is therefore provided, in accordance with an embodiment of the present invention, a method for communication, including running a navigation application on a mobile navigation device, which has a display and communicates over a wireless network with a navigation server, so as to present to a user navigation instructions from the navigation server on the display of the mobile navigation device. A widget chosen by the user is activated to run on the mobile navigation device in conjunction with the navigation application. Responsively to activating the widget, an interactive user interface element is overlaid on the navigation instructions on the display, indicating an availability of a location-based service at a location specified by the navigation instructions. Upon receiving an input from the user via the interactive user interface element invoking the service, the service is provided to the user at the specified location via the mobile navigation device while continuing to present the navigation instructions.

Typically, the navigation instructions include a map presented on the display of the mobile navigation device, and overlaying the interactive user interface element includes marking the specified location on the map. Providing the service may include initiating the service at the specified location after the user has navigated to the specified location in response to the navigation instructions.

In a disclosed embodiment, activating the widget includes receiving from the user a selection of the widget from a menu presented on the display of the mobile navigation device.

In some embodiments, providing the service includes establishing communication between the mobile navigation device and a provider of the service at the location. Establishing the communication may include conveying to the provider of the service an indication of the specified location. Additionally or alternatively, establishing the communication includes initiating the communication between the mobile navigation device and a network end-node other than the navigation server.

In one embodiment, providing the service includes furnishing the service, such as a paid parking service, to a vehicle in which the user is traveling.

There is also provided, in accordance with an embodiment of the present invention, apparatus for communication, including a memory and a processor, which is configured to read navigation information from the memory and to communicate over a wireless network with a mobile navigation device running a navigation application, so as to cause the mobile navigation device to present navigation instructions to a user on a display. The processor is configured, upon selection by the user of a widget to run in conjunction with the navigation application, to download the widget over the wireless network to the mobile navigation device, so that when run on the mobile navigation device, the widget causes an interactive user interface element to be overlaid on the navigation instructions on the display so as to indicate an availability of a location-based service at a location specified by the navigation instructions. Upon receiving an input from the user via the interactive user interface element invoking the service, the processor causes the service to be provided to the user at the specified location via the mobile navigation device while continuing to present the navigation instructions.

There is additionally provided, in accordance with an embodiment of the present invention, a computer software product, including a tangible computer-readable medium in which program instructions are stored, which instructions, when read by a processor in a mobile navigation device, which has a display and communicates over a wireless network with a navigation server, and which runs a navigation application so as to present to a user navigation instructions from the navigation server on the display, cause the processor to activate a widget chosen by the user to run on the mobile navigation device in conjunction with the navigation application, and responsively to activating the widget, to overlay on the navigation instructions on the display an interactive user interface element indicating an availability of a location-based service at a location specified by the navigation instructions, and to receive an input from the user via the interactive user interface element invoking the service, so as to cause the service to be provided to the user at the specified location via the mobile navigation device while continuing to present the navigation instructions.

The present invention will be more fully understood from the following detailed description of the embodiments thereof, taken together with the drawings in which:

### BRIEF DESCRIPTION OF THE DRAWINGS

FIG. 1 is a schematic pictorial illustration of a mobile navigation system, in accordance with an embodiment of the invention;

FIG. 2 is a communication flow diagram that schematically illustrates the operation of a widget, in accordance with an embodiment of the invention;

FIG. 3A is a schematic representation of the display screen of a mobile navigation device, illustrating operation of a widget in accordance with an embodiment of the invention;

FIG. 3B is a flow chart that schematically illustrates a method of operation of a widget, in accordance with the embodiment of FIG. 3A;

FIG. 4A is a flow chart that schematically illustrates a method of operation of a widget, in accordance with another embodiment of the invention;

FIG. 4B is a schematic representation of the display screen of a mobile navigation device, illustrating operation of a widget in accordance with the embodiment of FIG. 4B; and

FIG. 5 is a block diagram that schematically shows functional elements of a navigation system that includes widgets, in accordance with an embodiment of the invention.

### DETAILED DESCRIPTION OF EMBODIMENTS

### Overview

Personal navigation systems provide the user of a mobile navigation device with navigation instructions, typically in the form of a map with graphical directions and/or verbal guidance (printed on screen or enunciated by speech synthesis). A “mobile navigation device,” in the context of the present patent application and in the claims, means a portable computing device with a processor, display and communication interface, which runs a client navigation software application and communicates with a server in order to receive navigation instructions. Mobile navigation devices may thus include dedicated navigation devices, mobile phones, personal digital assistants, and computers designed for mobile use.

In general, once the navigation application program is installed on a mobile navigation device, the functionality of the software cannot easily be changed or enhanced. To address this difficulty, embodiments of the present invention that are described hereinbelow provide widgets that can offer user-selectable add-on capabilities to the basic navigation program. Some of these widgets are characterized by a high degree of integration with the functionality of the application software, whereby the add-on capabilities of the widget take full advantage of the underlying navigation infrastructure.

In some embodiments of the present invention, a navigation application runs on a mobile navigation device, which communicates over a wireless network with a navigation server and presents navigation instructions to a user on the device display. The user may specify widgets to run on the mobile navigation device in conjunction with the navigation application. When the user activates a widget, a corresponding interactive user interface element is overlaid on the navigation instructions on the display, to indicate locations at which a certain location-based service is available. The interactive user interface element is able to accept an input from the user (by clicking on the user interface element, for example, or by voice input) invoking the service. Thus, the widget both guides the user to the location of the service and enables the user to request and receive the service at the specific location via the mobile navigation device, while continuing to present the navigation instructions.

Details of the implementation and functionality of such widgets, as well as examples of services that may be provided by the widgets, are shown in the figures and described further hereinbelow.

### System Description

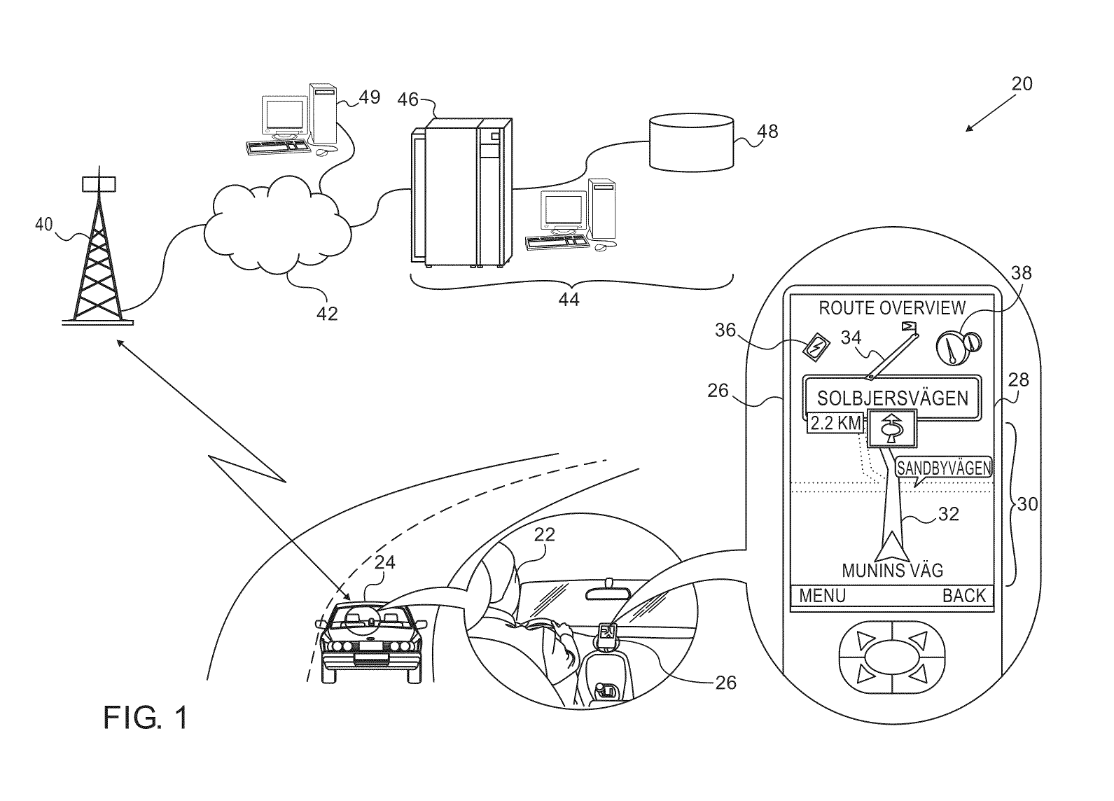

FIG. 1 is a schematic pictorial illustration of a mobile navigation system 20, in accordance with an embodiment of the present invention. A user 22 traveling in a vehicle 24 receives navigation instructions on a mobile navigation device 26. The device comprises a user interface that includes a display 28 (which may be a touch screen) on which a map 30 is presented. Typically, device comprises a processor, which runs a navigation application, and a communication interface, as well as other user controls. The current location of the device may be indicated by a built-in Global Positioning System (GPS) receiver. These elements are well known in the art and are omitted from the figures for the sake of simplicity. After user 22 has input his desired destination, device 26 presents navigation instructions, represented in this example by a directional icon 32 superimposed on map 30

Device 26 is also configured to run a selection of widgets in conjunction with the navigation application. The widgets are represented by corresponding user interface elements 34, 36, 38. To activate a given widget, the user selects the corresponding user interface element. Element 34, for example, represents a route overview widget, which displays information about the route that the user is currently following, including features such as traffic along the way, distance covered, or distance or time remaining to the destination. Other widgets may relate to location-based services, i.e., goods, services and information that are available to the user at certain locations along or near the route. Widgets associated with these types of services are described in greater detail hereinbelow.

In order to obtain route information and location-based services, device 26 communicates with a navigation server 44. For this purpose, device 26 typically sends and receives data signals over a wireless network (such as a cellular communication network) to and from a network base station 40. The base station relays the data to and from server 44 via a packet network 42, such as the Internet. Server 44 comprises a processor 46, typically a general-purpose computer processor, which runs server-side navigation application software. A memory 48 contains navigation data used by the application in generating maps and navigation directions for download to device 26.

In addition, memory 48 holds widget software programs. When user 22 requests a given widget (by selecting the corresponding user interface element, in the present example), server 44 downloads the appropriate program to device 26. This approach conserves memory on device 26, since only selected widgets are present in the device memory, and also facilitates billing by the operator of server 44 for widget-based services. Alternatively, the client-side widget software may be pre-provisioned on device 26 and then activated when invoked by the user.

The widget client software running on device 26 interacts with the navigation client application installed on device 26 to request and receive information. Additionally or alternatively, the widget client software may interact with widget server software running on server 44 in order to request and receive location-based services. Further alternatively or additionally, the widget client software on device 26 may communicate via network 42 with another network end-node, such as a server 49, in connection with a given service.

As noted above, device 26 and server 44 each comprise one or more general-purpose processors, which are programmed in software to carry out the functions that are described herein. This software may be downloaded to the respective processor in electronic form, over a network, for example. Additionally or alternatively, the software may be stored on tangible computer-readable media, such as optical, magnetic, or electronic memory media.

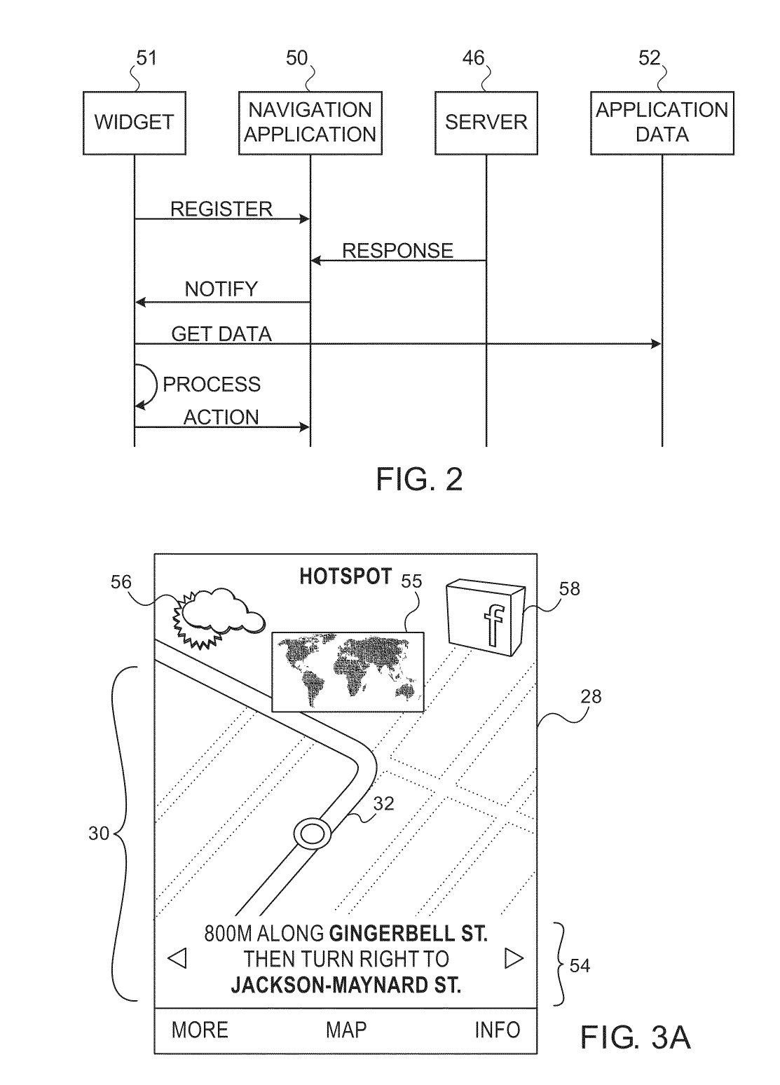

FIG. 2 is a communication flow diagram that schematically illustrates the operation of a widget 51 running on mobile navigation device 26, in accordance with an embodiment of the invention. The figure gives a high-level overview of the interaction of the widget with a navigation application 50 running on device 26, as well as with software run by processor 46 of server 44.

When widget 51 is activated, it registers with application 50. The registration message notifies the application of the presence of the widgets and requests notification of specific events occurring in the application. An event in this context may be any sort of occurrence that the navigation system can register and respond to. Events may include, for example:
Location events, such as receiving a GPS location reading.
Server events, such as receiving a response from server 44 to a request sent by application 50. (A response embodies the result set that the server calculates upon receiving a request from device 26. A single request may generate several responses.)
Device events, such as receiving a text message or incoming call, or a low-battery notification.
Navigation events, such as a notification that a speed camera or other landmark is approaching, or a traffic notification.
   Additionally or alternatively, other internal occurrences relating to application 50 may be classified as events that trigger a response. Typically, application 50 has an application program interface (API) that can be used by the programmer of the widget to request and receive any desired type of event that is defined in the API.

In the example shown in FIG. 2, widget 51 registers to receive notification of certain responses from the server, such as route responses. Thus, upon receiving a route response, application 50 passes a notification to widget 51, typically via the API, that a response has been received. Upon receiving the notification, the widget fetches relevant application data 52, such as an identification of certain locations on the route. The data may be available already on device 26 (such as route characteristics and directions downloaded from server 44). Alternatively or additionally, the widget may itself request data from navigation server 44 or from another server 49.

The widget processes these data and then performs the action that it is programmed to carry out. For example, the widget may instruct application 50 to present new information on display 28. Additionally or alternatively, the widget may invoke a specific location-based service, such as those described hereinbelow.

### Widget Examples

System 20 is capable of supporting a wide variety of types of widgets. The widgets in the embodiments that follow, however, have the unique feature of enabling the user to access location-based services, using on-screen interactive elements that are closely integrated with navigation instructions. In particular, these widgets use navigation instructions that are overlaid graphically on the display provided by the mobile navigation device to show the availability of a location-based service at a certain location. When the user reaches the location in question, he or she can then invoke the interactive element in order to receive the service in question.

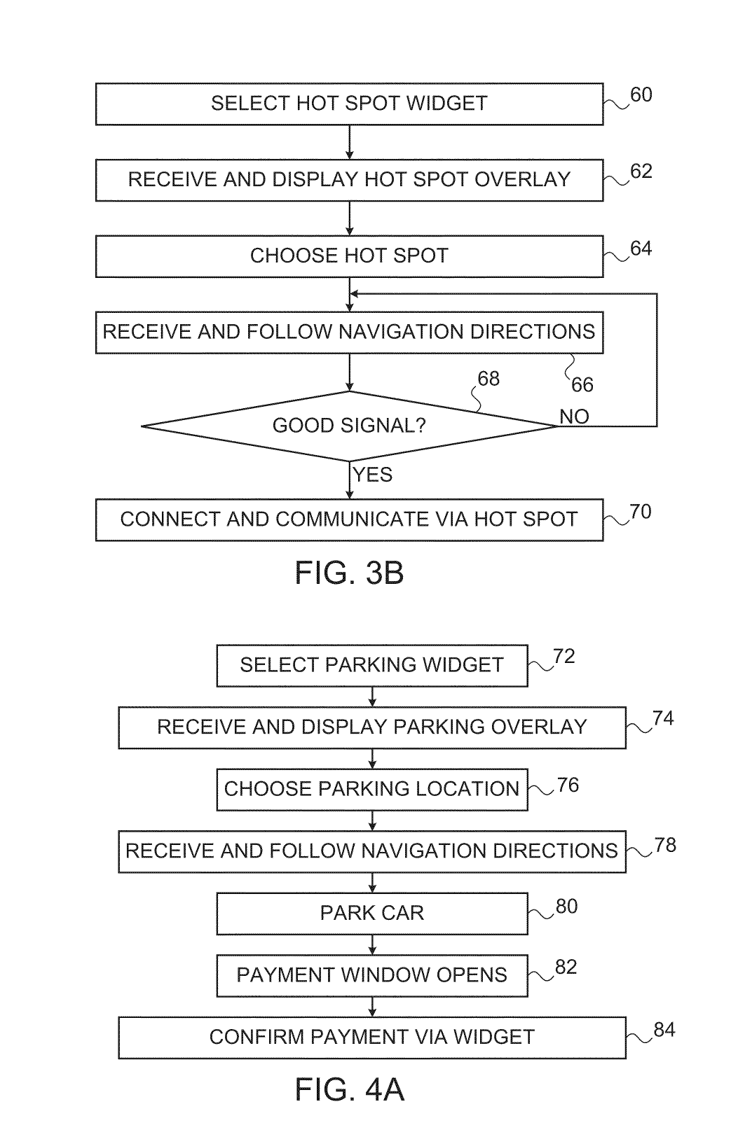

FIG. 3A, for example, is a schematic representation of display 28 of mobile navigation device 26, illustrating a hotspot access widget in accordance with an embodiment of the invention. Display 28 shows map 30, as well as verbal instructions 54. A user interface element 55 enables user 22 (FIG. 1) to find the locations of WiFi hotspots near the route on which he is traveling. The user may wish to connect to the wireless local area network at one of these locations, for example, in order to communicate at higher speed and/or at lower cost than is possible over the cellular connection used by device 26 while the user is driving. The hotspot access widget may be deployed by the WiFi service provider, who offers the service for a fee.

Other user interface elements 56, 58 in FIG. 3A allow the user to invoke other location-based services, which may be offered for a fee or gratis. For example, element 56 represents a weather widget, which reports to the user on weather conditions along the route of travel. Element 58 represents a social networking widget, which shows the user the locations of his or her friends near the route and may also enable the user to establish communications with selected friends while traveling. As another example, a local advertising widget may register to be notified when device 26 receives a map response from server 44. Upon notification, the widget notes the area covered by the map and its scale, checks these parameters against a database of advertisers, and displays an appropriate banner or other overlay on the map if a local advertiser is within range. The overlay may enable the user to place an order with the advertiser, for pickup when the user reaches the appropriate location.

FIG. 3B is a flow chart that schematically illustrates the operation of the hot spot widget, in accordance with an embodiment of the present invention. User 22 activates the hot spot widget by selecting user interface element 55, at a widget selection step 60. For example, the user may touch or click on element 55 on display 28 or may give a voice command. Device 26 notifies server 44 (or notifies a separate widget server) of the user's selection, and the server accordingly downloads the widget program to device 26, followed by data indicating hotspot locations near the user's present route. Device 26 overlays these locations in the form of icons or other marking on map 30, at an overlay display step 62.

At this point, user 22 may choose one of the hot spots, by touching or clicking on the corresponding icon, for example, at a hot spot selection step 64. If necessary, device 26 may then generate new navigation instructions directing the user to the location of the selected hot spot, or may download these instructions from server 44. The navigation instructions are presented to the user on display 28, at a direction presentation step 66.

The hot spot widget may monitor the distance of device 26 from the selected hot spot. When device 26 is within a certain range, the widget may instruct the WiFi interface of device 26 to begin scanning for an access point signal and may check the signal strength, at a signal checking step 68. Device 26 continues to present navigation instructions until it receives a strong WiFi signal. At that point, the hot spot widget notifies the user that WiFi communication is available. Device 26 connects to the hot spot (automatically, or under the control of the widget or of the user directly), and communications proceed, at a hot spot communication step 70.

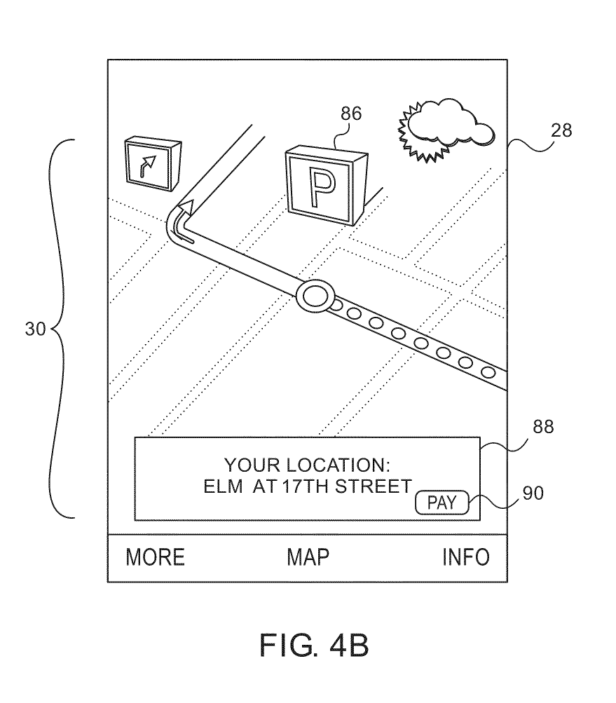

FIGS. 4A and 4B schematically illustrate the operation of another widget-activated location-based service—in this case a parking service—in accordance with another embodiment of the present invention. FIG. 4A is a flow chart that illustrates the operation of a parking widget, while FIG. 4B illustrates the user interface of the widget on screen 28. The parking widget may be deployed by a municipal or private parking service, which may also collect payment for use of parking spaces, as described below.

User 22 activates the parking service by selecting the corresponding widget, at a widget selection step 72. As in the preceding embodiment, the user may select the widget by clicking or pressing on a corresponding user interface element 86. In response to the user selection, device 26 requests and receives from server 44 (or from another server) an overlay for map 30 showing the locations of available parking spaces near the current route. The user may choose one of the parking locations on display 28, at a location selection step 76. Device 26 will then present navigation directions on display 28 to guide the user to the selected parking location, at a direction presentation step 78.

When user 22 reaches the chosen parking location, he parks vehicle 24, at a parking step 80. If there is a charge for the parking service, the parking widget will then open a payment window 88 on display 28, at a payment request step 82. The window may open at the request of the user, or it may alternatively open automatically when the widget receives information that the vehicle has stopped in the selected parking location. The widget is able to determine the parking location automatically, based on location information reported by device 26, and reports the location to a parking server (such as server 49 in FIG. 1, for example).

The user then selects a “PAY” button on display 28 in order to confirm the payment, at a payment confirmation step 84. The parking fee may be charged to the user's cellular account or to some other pre-paid or post-paid account. As noted above, there is no need for the user to input any location information, since the parking widget has already reported the location to the parking service. Thus, the widget aids the user (and the service provider) both in guiding the user to the service location and in collecting payment for the service.

The hot spot and parking widgets described above are just two examples among many types of widgets that are supported by embodiments of the present invention. Generally speaking, widgets can be of various types, for instance:
A list widget, which displays a list of items, such as a list of traffic event on the route.
A carousel widget, which displays several operations the user can choose from, such as finding the nearest restaurant in each of a number of different chains.
A floating widget, which can appear in one of several fixed locations on the screen, such as a widget displaying parking information at the bottom left corner of the screen.

Further examples of specific widgets that can be offered in system 20 are described in the above-mentioned U.S. Provisional Patent Application 61/151,530.

### Details of Implementation

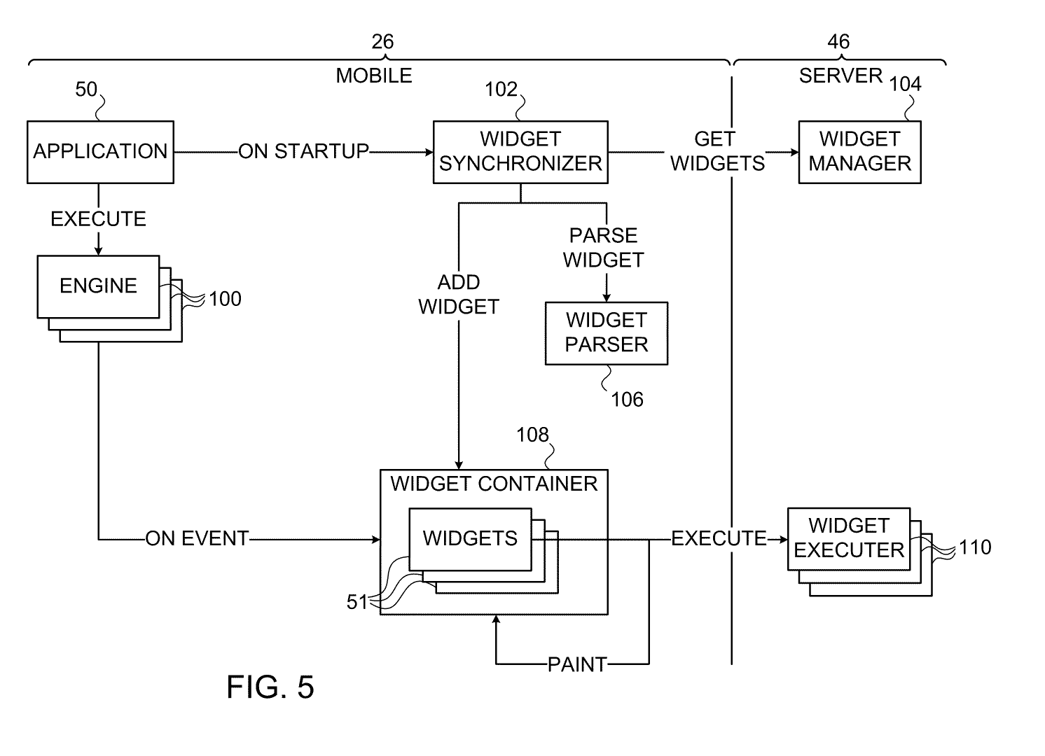

FIG. 5 is a block diagram that schematically shows functional elements of navigation system 20 that relate particularly to widgets 51, in accordance with an embodiment of the invention. The diagram shows software components, some of which run on mobile navigation device 26, while others run on processor 46 of server 44.

Each widget 51 has the following attributes:
Widget name to display on device 26.
The events monitored by the widget.
Visual attributes, such as an icon and/or other overlay
A Uniform Resource Locator (URL) to use, if necessary, to invoke server-side execution (by a widget executer 110, which may comprise, for example, a servlet or other Web server software component).
   The widget attributes may be defined by a developer using a novel scripting language, which allows both for setting the above attributes and creating simple flow descriptions. Details of such a language are presented below in an Appendix.

On the client side (i.e., in device 26), mobile navigation application 50 uses a number of software engines 100, which are responsible, inter alia, for emitting events that cause widgets to execute. For example, each time the location of the device changes, a locationChanged( ) event is emitted. A software wizard may be provided to enable the developer to register a given widget so that it will receive specified events from a predefined list.

Typical engine types and corresponding events include:
A navigation engine is executed whenever a user initiates a turn-by-turn navigation flow (whether in vehicle 24 or in a pedestrian mode). The following events are typically available from the navigation engine:
   Navigation started
   Arrived at destination
   Instruction changed
   Traffic changed
   Traffic ahead
   Speed camera ahead
   New route was downloaded
   User did not follow instructions
Widgets are able to retrieve the following information from the navigation engine:
   Distance to destination
   Route length
   Current instruction
   List of next X instructions from current location
   List of traffic events ahead
   Route polyline (a sequence of vectors corresponding to the route direction)
   Route area
The information available from the navigation engine during navigation may include not only the route polyline, but also the roads around the route leading to the chosen destination. This information enables widgets to add features not only related directly to the route, but also with respect to locations in the area surrounding of the route.
A location engine is executed on startup of application and is responsible for notifying widgets of any change in the location of device 26. The location can be based on GPS coordinates, information provided by the cellular network, or any other available method, such as WiFi location. The location engine typically provides the following events:
   Location changed
   GPS disconnected
   GPS connected
Widgets are able to retrieve the following information from the location engine:
   Location coordinate
   Location accuracy
   Type of location (GPS, Cell ID, other)
   Speed
   Location history (up to X points)
When a widget registers for “location changed” events, it may also specify the frequency of notification.
A device engine is executed on startup of application 50 and is responsible for notifying widgets of any device-specific events that occur, for example:
   Incoming call
   Incoming text message
   Incoming e-mail

At startup of application 50, and thereafter when the user requests a new widget, a widget synchronizer 102 downloads the requested widgets from a widget manager 104 running on processor 46 of server 44. The widget manager may also trigger and track billing for widgets. A widget parser 106 analyzes the widgets that have been downloaded and performs the following operations:
Translate the attributes of the widget into code.
Add the widget to the widget collection, held in a widget container 108.
Register the widget to receive relevant events from one or more of engines 100.

Widget container 108 runs the widget code and takes appropriate action on each received event. For example, the widget container may modify graphical elements (“paint”) on display 28 of device 26, and it may invoke widget executers 110 to carry out server actions when required.

It will be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

### APPENDIX

### Widget Scripting Language (WSL)

WSL is a scripting language that supports the feature set of the widgets and enables developers to define new widgets quickly and easily. WSL allows the developer to set up descriptive attributes of the widget (name, description, which widget container to attach to); the visual attributes of the widget (colors, fonts, images, layers, etc); the events it is registered to receive; the data to be displayed; and the URL for server actions. WSL also supports conditions, variables and mathematical functions that can be defined in order to support more advanced widgets. As noted above, parser 106 compiles and translates the script into an active object that implements the widget. The WSL script can be stored and transmitted to device 26 in compact binary format.

The script listed below belongs to a route overview widget. The widget creates a graphical overlay on the route map including the following elements:
Visual layer 1—green vertical bar of fixed size.
Visual layer 2—car location as a yellow arrow—dynamic.
Visual layer 3—traffic on the road—dynamic.
ETA information—at the top of the green bar—dynamic

The widget is attached to the navigation widget container and listens to the following events:
Location changed—every 5 seconds (5000 ms).
Traffic changed.

The widget uses the following data:
Distance to the destination ($distance)
Traffic events ahead ($traffic)
Time left to reach destination ($time_to_dest)
Route length ($route_length)
   (The ‘$’ sign is used to access data variables.)

The widget defines the following variables:
Position of the user relative to the destination (relative_distance).
Position of the traffic condition ahead relative to the destination (relative_traffic_distance).

The widget is defined by the following WSL code:

WSL CODE FOR ROUTE OVERVIEW WIDGET

```
<OverviewWidget name=“Overview” container=“Navigation”>
  <Display>
    <Layer id=“route_layer” img=“green_bar.gif”
          pos=“bottom_right”/>
    <Layer id=“car_layer” img=“car.gif”
          pos_rel=“route_layer”
          pos_ref=“bottom”/>
    <Layer id=“traffic_layer” img=“traffic.gif”
            pos_rel=“route_layer” pos_ref=“bottom”/>
    <Text id=“eta” font=“medium” color=“#00BB00” />
  </Display>
  <Vars>
    <Var id=“relative_distance”
          value=“$distance/$route_length”/>
    <Var id=“relative_traffic_distance”
          value=“$traffic.distance/$route_length”/>
  </Vars>
  <Events>
    <Event name=“locationChanged” frequency=“5000”
            action=“drawImage” params=“car_layer”
            data=“relative_distance” />
    <Event name=“trafficChanged” frequency=“0”
            action=“drawImage”
            params=“traffic_layer”/>
    <Event name=“locationChanged” frequency=“5000”
            action=“drawText” params=“eta”
            data=“$time_to_dest” />
  </Events>
</OverviewWidget>
```

1. A method for communication, comprising:
running a navigation application on a mobile navigation device, which has a display and communicates over a wireless network with a navigation server, so as to present to a user navigation instructions from the navigation server on the display of the mobile navigation device;
activating a widget chosen by the user to run on the mobile navigation device in conjunction with the navigation application;
responsively to activating the widget, overlaying on the navigation instructions on the display an interactive user interface element indicating an availability of a location-based service at a location specified by the navigation instructions;
receiving an input from the user via the interactive user interface element invoking the service; and
providing the service to the user at the specified location via the mobile navigation device while continuing to present the navigation instructions.

2. The method according to claim 1, wherein the navigation instructions comprise a map presented on the display of the mobile navigation device, and wherein overlaying the interactive user interface element comprises marking the specified location on the map.

3. The method according to claim 1, wherein activating the widget comprises receiving from the user a selection of the widget from a menu presented on the display of the mobile navigation device.

4. The method according to claim 1, wherein providing the service comprises initiating the service at the specified location after the user has navigated to the specified location in response to the navigation instructions.

5. The method according to claim 1, wherein providing the service comprises establishing communication between the mobile navigation device and a provider of the service at the location.

6. The method according to claim 5, wherein establishing the communication comprises conveying to the provider of the service an indication of the specified location.

7. The method according to claim 5, wherein establishing the communication comprises initiating the communication between the mobile navigation device and a network end-node other than the navigation server.

8. The method according to claim 1, wherein providing the service comprises furnishing the service to a vehicle in which the user is traveling.

9. The method according to claim 8, wherein the service comprises a paid parking service.

10. Apparatus for communication, comprising:
a memory; and
a processor, which is configured to read navigation information from the memory and to communicate over a wireless network with a mobile navigation device running a navigation application, so as to cause the mobile navigation device to present navigation instructions to a user on a display,
wherein the processor is configured, upon selection by the user of a widget to run in conjunction with the navigation application, to download the widget over the wireless network to the mobile navigation device, so that when run on the mobile navigation device, the widget causes an interactive user interface element to be overlaid on the navigation instructions on the display so as to indicate an availability of a location-based service at a location specified by the navigation instructions, and
wherein upon receiving an input from the user via the interactive user interface element invoking the service, the processor causes the service to be provided to the user at the specified location via the mobile navigation device while continuing to present the navigation instructions.

11. The apparatus according to claim 10, wherein the navigation instructions comprise a map presented on the display of the mobile navigation device, and wherein the interactive user interface element indicates the specified location on the map.

12. The apparatus according to claim 10, wherein the widget is selected by the user from a menu presented on the display of the mobile navigation device.

13. The apparatus according to claim 10, wherein the processor is configured to cause the service to be initiated at the specified location after the user has navigated to the specified location in response to the navigation instructions.

14. The apparatus according to claim 10, wherein the widget causes the mobile navigation device to establish communication with a provider of the service at the location.

15. The apparatus according to claim 14, wherein the widget causes the provider of the service to receive an indication of the specified location.

16. The apparatus according to claim 14, wherein the widget causes the mobile navigation device to establish communication with a network end-node other than the navigation server.

17. The apparatus according to claim 10, wherein the service is provided to a vehicle in which the user is traveling.

18. The apparatus according to claim 17, wherein the service comprises a paid parking service.

19. A computer software product, comprising a tangible computer-readable medium in which program instructions are stored, which instructions, when read by a processor in a mobile navigation device, which has a display and communicates over a wireless network with a navigation server, and which runs a navigation application so as to present to a user navigation instructions from the navigation server on the display, cause the processor to activate a widget chosen by the user to run on the mobile navigation device in conjunction with the navigation application, and responsively to activating the widget, to overlay on the navigation instructions on the display an interactive user interface element indicating an availability of a location-based service at a location specified by the navigation instructions, and to receive an input from the user via the interactive user interface element invoking the service, so as to cause the service to be provided to the user at the specified location via the mobile navigation device while continuing to present the navigation instructions.
